(19) United States
(12) Patent Application Publication
(10) Pub. No.: US 2013/0311185 A1
(43) Pub. Date: Nov. 21, 2013

(54) METHOD APPARATUS AND COMPUTER PROGRAM PRODUCT FOR PROSODIC TAGGING

(71) Applicants: Rohit Atri, Bangalore (IN); Sidharth Patil, Bangalore (IN)

(72) Inventors: Rohit Atri, Bangalore (IN); Sidharth Patil, Bangalore (IN)

(73) Assignee: NOKIA CORPORATION, Espoo (FI)

(21) Appl. No.: 13/983,413

(22) PCT Filed: Jan. 19, 2012
(86) PCT No.: PCT/FI12/50044

§ 371 Date: Aug. 2, 2013

(30) Foreign Application Priority Data
Feb. 15, 2011 (IN) 422/CHE/2011

(51) Int. Cl. G10L 15/08; G10L 17/00

(52) U.S. Cl. CPC G10L 15/08; G10L 17/00
USPC 704/250

(57) ABSTRACT

In accordance with an example embodiment a method and apparatus are provided. The method comprises identifying at least one subject voice in one or more media files. The method also comprises determining at least one prosodic feature of the at least one subject voice. The method also comprises determining at least one prosodic tag for the at least one subject voice based on the at least one prosodic feature.

### TECHNICAL FIELD

Various implementations relate generally to method, apparatus, and computer program product for managing media files in apparatuses.

### BACKGROUND

Media content such as audio and/or audio-video content is widely accessed in variety of multimedia and other electronic devices. At times, people may want to access particular content among a pool of audio and/or audio-video content. People may also seek organized/clustered media content, which may be easy to access as per their preferences or requirements at particular moments. Currently, clustering of audio/audio-video content is primarily performed based on certain metadata stored in text format within the audio/audio-video content. As a result, audio/audio-video content may be sorted into categories such as genre, artist, album, and the like. However, such type of clustering of the media content is generally passive.

### SUMMARY OF SOME EMBODIMENTS

Various aspects of example embodiments are set out in the claims.

In a first aspect, there is provided a method comprising: identifying at least one subject voice in one or more media files; determining at least one prosodic feature of the at least one subject voice; and determining at least one prosodic tag for the at least one subject voice based on the at least one prosodic feature.

In a second aspect, there is provided an apparatus comprising: at least one processor; and at least one memory comprising computer program code, the at least one memory and the computer program code configured to, with the at least one processor, cause the apparatus at least to perform: identifying at least one subject voice in one or more media files; determining at least one prosodic feature of the at least one subject voice; and determining at least one prosodic tag for the at least one subject voice based on the at least one prosodic feature.

In a third aspect, there is provided a computer program product comprising at least one computer-readable storage medium, the computer-readable storage medium comprising a set of instructions, which, when executed by one or more processors, cause an apparatus at least to perform: identifying at least one subject voice in one or more media files; determining at least one prosodic feature of the at least one subject voice; and determining at least one prosodic tag for the at least one subject voice based on the at least one prosodic feature.

In a fourth aspect, there is provided an apparatus comprising: means for identifying at least one subject voice in one or more media files; means for determining at least one prosodic feature of the at least one subject voice; and means for determining at least one prosodic tag for the at least one subject voice based on the at least one prosodic feature.

In a fifth aspect, there is provided a computer program comprising program instructions which when executed by an apparatus, cause the apparatus to: identifying at least one subject voice in one or more media files; determining at least one prosodic feature of the at least one subject voice; and determining at least one prosodic tag for the at least one subject voice based on the at least one prosodic feature.

### BRIEF DESCRIPTION OF THE FIGURES

For more understanding of example embodiments, reference is now made to the following descriptions taken in connection with the accompanying drawings in which:

FIG. 1 illustrates a device in accordance with an example embodiment;

FIG. 2 illustrates an apparatus configured to prosodically tag one or more media files in accordance with an example embodiment;

FIG. 3 is a schematic diagram representing an example of prosodically tagging of media files, in accordance with an example embodiment;

FIG. 4 is a schematic diagram representing an example of clustering of media files in accordance with an example embodiment; and

FIG. 5 is a flowchart depicting an example method for tagging one or more media files in accordance with an example embodiment.

### DETAILED DESCRIPTION

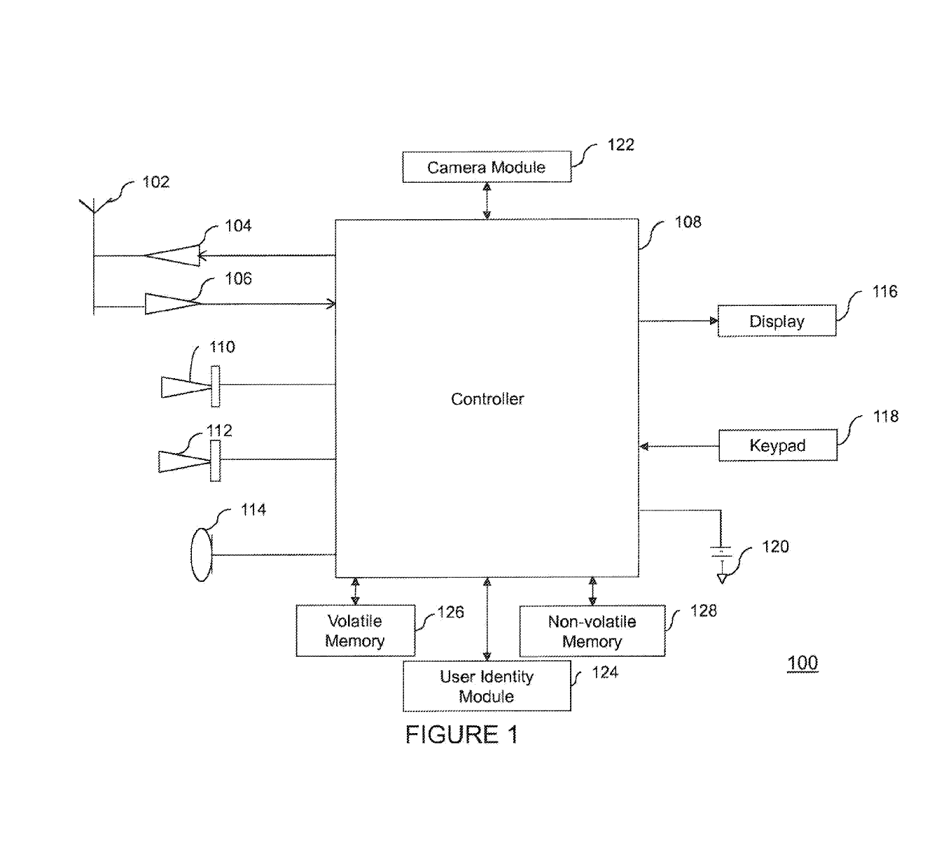

Example embodiments and their potential effects are understood by referring to FIGS. 1 through 5 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9 G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively or additionally, the camera module 122 may include only the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile Random Access Memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

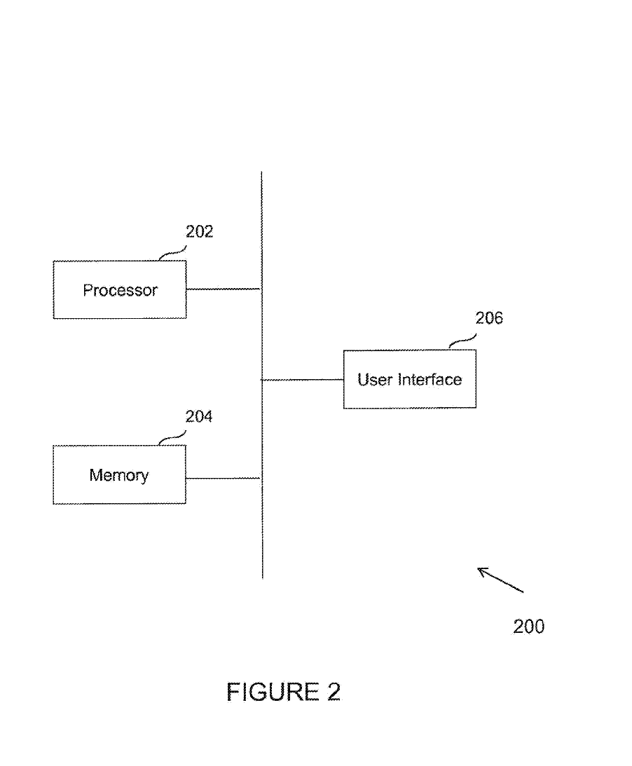

FIG. 2 illustrates an apparatus 200 configured to prosodically tag one or more media files, in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively or additionally, embodiments may be employed on a combination of devices including, for example, those listed above. Accordingly, various embodiments may be embodied wholly at a single device, for example, the device 100 or in a combination of devices. It should be noted that some devices or elements described below may not be mandatory and some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory include random access memory, dynamic random access memory, static random access memory, and the like. Some example of the non-volatile memory includes hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data for processing by the processor 202. Additionally or alternatively, the memory 204 may be configured to store instructions for execution by the processor 202. In an example embodiment, the memory 204 may be configured to store content, such as a media file.

An example of processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. In some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the processor 202 is configured to, with the content of the memory 204, and optionally with other components described herein, to cause the apparatus 200 to identify at least one subject voice in one or more media files. The one or more media files may be audio files, audio-video files, or any other media file having audio data. In one example embodiment, the media files may comprise data corresponding to voices of one or more subjects such as one or more persons. Additionally or alternatively, the one or more subjects may also be one or more non-human beings, one or more manmade machines, one or more natural objects, or one or more combination of these. Examples of the non-human creatures may include, but are not limited to, animals, birds, insects, or any other non-human living organisms. Examples of the one or more manmade machines may include, but are not limited to, electrical, electronic, or mechanical appliances, or any other scientific home appliances, or any other machine that can generate voice. Examples of the natural objects may include, but are not limited to, waterfall, river, wind, trees and thunder. The media files may be received from internal memory such as hard drive, random access memory (RAM) of the apparatus 200, or from the memory 204, or from external storage medium such as digital versatile disk (DVD), compact disk (CD), flash drive, memory card, or from external storage locations through the Internet, Bluetooth®, and the like. In an example embodiment, a processing means may be configured to identify different subject voices in the media files. An example of the processing means may include the processor 202, which may be an example of the controller 108.

In an example embodiment, the processor 202 is configured to, with the content of the memory 204, and optionally with other components described herein, to cause the apparatus 200 to determine at least one prosodic feature of the at least one subject voice. Example of the prosodic features of a voice may comprise, but are not limited to, loudness, pitch variation, tone, tempo, rhythm and syllable length. In an example embodiment, determining the prosodic feature may comprise measuring and/or quantizing the prosodic features to numerical values corresponding to the prosodic features. In an example embodiment, a processing means may be configured to determine the at least one prosodic feature of the at least one subject voice. An example of the processing means may include the processor 202, which may be an example of the controller 108.

In an example embodiment, the processor 202 is configured to, with the content of the memory 24, and optionally with other components described herein, to cause the apparatus 200 to determine at least one prosodic tag for the at least one subject voice based on the at least one prosodic feature. A particular subject voice may have certain pattern in its prosodic features. In one example embodiment, a prosodic tag for a subject voice may be determined based on the pattern of the prosodic features for the subject voice. In some example embodiments, a prosodic tag for a subject voice may be determined based on the numerical values assigned to the prosodic features for the subject voice. In an example embodiment, the prosodic tag for a subject voice may refer to a numerical value calculated from numerical values corresponding to prosodic features of the subject voice. In another example embodiment, the prosodic tag for a subject voice may be a voice sample of the subject voice. In some other example embodiments, the prosodic tag may be a combination of the prosodic tags of the above example embodiments, or may include any other way of representation of the subject voice. In an example embodiment, a processing means may be configured to segment the image in the foreground region and the background region. An example of the processing means may include the processor 202, which may be an example of the controller 108.

In an example embodiment, the processor 202 may be configured to facilitate storing of the prosodic tag for the at least one subject voice. In an example embodiment, the processor 202 may be configured to store the name of a subject and the prosodic tag corresponding to the subject. In an example embodiment, once a distinct prosodic tag is determined, user input may be utilized to recognize the name of the subject to which the prosodic tag belongs. The user input may be provided through the user interface 206. The processor 202 is configured to store the prosodic tags and corresponding names of subjects in a database. An example of the database may be the memory 204, or any other internal storage of the apparatus 200 or any external storage. In some embodiments, there may be prosodic tags, for which names of corresponding subjects may not be determined and such prosodic tags may be stored as unidentified prosodic tags. In an example embodiment, a processing means may be configured to facilitate storing of the prosodic tag for the at least one subject voice. An example of the processing means may include the processor 202, which may be an example of the controller 108.

In an example embodiment, the processor 202 is further configured to cause the apparatus 200 to tag the media files based on the at least one prosodic tag. In an example embodiment, tagging a media file comprises enlisting one or more prosodic tags corresponding to one or more subject voices that may be present in the media file and storing the list of prosodic tags in a database. For example, if a media file includes voices of three different subjects James, Mikka and John, the media file may be tagged with prosodic tag (PT) such as PT_{James}, PT_{Mikka} and PT_{John}. In an example, let the media files such as audio files A1, A2 and A3, and audio-video files such as AV1, AV2 and AV3 are being processed. Let different prosodic tags such as PT1, PT2, PT3, PT4, PT5 and PT6 are determined from the media files A1, A2, A3 and AV1, AV2, AV3. For this example, the following table 1 represents tagging of the media files, as represented by the media files and corresponding prosodic tags

TABLE 1

| Media Files | Prosodic Tags |
|---|---|
| A1 | PT1, PT6 |
| A2 | PT2, PT5 |
| A3 | PT1, PT2 |
| AV1 | PT3, PT6 |
| AV2 | PT3, PT4, PT5 |
| AV3 | PT2, PT4 |

The table 1 represents tagging of the media files, for example, the media file A1 is prosodically tagged with PT1 and PT6, and the media file AV1 is prosodically tagged with PT3 and PT5. In an example embodiment, the table 1 may be stored in a database. In an example embodiment, a processing means may be configured to facilitate storing of the prosodic tag for the at least one subject voice. An example of the processing means may include the processor 202, which may be an example of the controller 108.

In an example embodiment, the processor 202 is further configured to cause the apparatus 200 to cluster the media files based on the prosodic tags. In an example embodiment, a cluster of media files corresponding to a prosodic tag comprises those media files that comprise the subject voice corresponding to the prosodic tag. In an example embodiment, clustering of the media files may be performed by the processor 202 automatically based on various prosodic tags determined in the media files. In another example embodiment, clustering of the media files may be performed in response of a user query or under some software program, control, or instructions.

In an example embodiment, in case of automatic clustering, for each prosodic tag PTn, all media files ‘Ai’ and ‘AVi’ that comprise voices corresponding to the prosodic tag PTn are clustered. In an example, a cluster corresponding to prosodic tage PTn (C_{PTN}) may be represented as C_{PTN}={Ai, AVi}, where ‘Ai’ represents all audio files that are tagged with prosodic tag PTn, and ‘AVi’ represents all the audio-video files that are tagged with prosodic tag PTn. The following TABLE 2 tabulates different clusters based on the prosodic tags.

TABLE 2

| Clusters | Media Files |
|---|---|
| C_{PT1} | A1, A3 |
| C_{PT2} | A2, A3, AV3 |
| C_{PT3} | AV1, AV2 |
| C_{PT4} | AV2, AV3 |
| C_{PT5} | A2, AV2 |
| C_{PT6} | A1, AV1 |

In an example embodiment, media files may be clustered based on a query from a user, software program or instructions. For example, a user query may be received to form clusters of PT1 and PT4 only. In an example embodiment, clusters of the media files which are tagged by PT1 and PT4 may be generated separately or in a combined form. For example two different clusters, such as cluster for PT1 as CPT1={A1, A3}, and cluster for PT4 as CPT4={AV2, AV3}. In another example embodiment, a combined cluster such as CPT12={A1, A3, AV2, AV3} may also be formed.

In an example embodiment, the apparatus 200 may comprise a communication device. An example of the communication device may include, but is not limited to, a mobile phone, a personal digital assistant (PDA), a notebook, a tablet personal computer (PC), and a global positioning device (GPS). The communication device may comprise a user interface circuitry and user interface software configured to facilitate a user to control at least one function of the communication device through use of a display and further configured to respond to user inputs. The user interface circuitry may be similar to the user interface explained in FIG. 1 and the description is not included herein for sake of brevity of description. Additionally or alternatively, the communication device may include a display circuitry configured to display at least a portion of a user interface of the communication device, the display and display circuitry configured to facilitate the user to control at least one function of the communication device. Additionally or alternatively, the communication device may include typical components such as a transceiver (such as transmitter 104 and a receiver 106), volatile and non-volatile memory (such as volatile memory 126 and non-volatile memory 128), and the like. The various components of the communication device are not included herein for the sake of brevity of description.

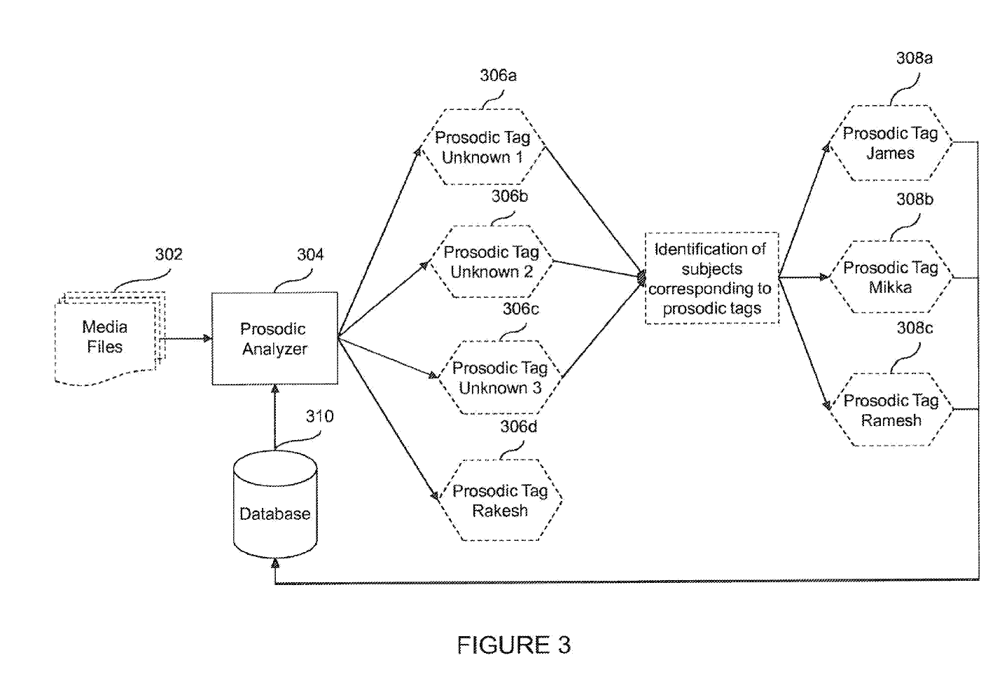

FIG. 3 is a schematic diagram representing an example of prosodic tagging of media files, in accordance with an example embodiment. One or more media files 302 such as audio files and/or audio-video files may be provided to a prosodic analyzer 304. The prosodic analyzer 304 may be embodied in, or controlled by the processor 202 or the controller 108. The prosodic analyzer 304 is configured to identify the presence of voices of different subjects, for example, different people in the media files 302.

In an example embodiment, if a distinct voice is identified, the prosodic analyzer 304 is configured to measure the various prosodic features of the voice. In an example embodiment, the prosodic analyzer 304 may be configured to analyze a particular duration of the voice to measure the prosodic features. The duration of the voice that is analyzed may be pre-defined or may be chosen as that is sufficient for measuring the prosodic features of the voice. In an example embodiment, measurement of the prosodic features of a newly identified voice may be utilized to form a prosodic tag for the newly identified voice.

In one example embodiment, the prosodic analyzer 304 may provide output that comprises prosodic tags for the newly identified voices. The prosodic analyzer 304 may also provide output comprising prosodic tags that are already determined and are stored in a database. For example, prosodic tags for voices of some subjects may already be present in the database. In the example shown in FIG. 3, a set of newly determined prosodic tags are shown as unknown prosodic tags (PTs) 306a-306c. A prosodic tag stored in a database is also shown as PT 306d, for example, the PT 306d may correspond to voice of a person named ‘Rakesh’. As such, the PT 306d for the subject ‘Rakesh’ is already identified and present in the database, however, the PT 306d may also be provided as output by the prosodic analyzer 304 as the voice of ‘Rakesh’ may be present in the media files 302.

In an example embodiment, an unknown prosodic tag (for example, the PT 306a) determined by the prosodic analyzer 304 may correspond to voice of a particular subject. In an example embodiment, the voice corresponding to the PT 306a may be analyzed to identify the name of the subject to which the voice belongs. In an example embodiment, user input may be utilized to identify the name of the subject to which the PT 306a belongs. In one arrangement, the user may be presented with a short playback of voice samples from media files for which the PT 306a is determined. As shown in FIG. 3, from the identification process of subjects corresponding to the prosodic tags, it may be identified that the PT 306a belongs to a known subject (for example, ‘James’). In an example embodiment, the PT 306a may be renamed as ‘PT James’ (shown as 308a). ‘PT James’ now represents the prosodic tag for voice of ‘James’. Similarly, voice corresponding to PT 306b may be identified as ‘Mikka’ and PT306b may be renamed as ‘PT_{Mikka}’ (shown as 308b). Similarly, voice corresponding to PT 306c may be identified as ‘Ramesh’ and PT 306c may be renamed as ‘PT_{Ramesh}’ (shown as 308c).

In an example embodiment, once the names of the subjects corresponding to PT 306a, PT 306b and PT 306c are identified, these prosodic tags are stored corresponding to the names of the subjects in a database 310. The database 310 may be the memory 204, or any other internal storage of the apparatus 200 or any external storage. In an example embodiment, there may be some unknown prosodic tags that may not identified by the user input or by any other mechanism, such unknown tags may be stored as unidentified prosodic tags in the database 310.

In an example embodiment, as the subjects corresponding to the prosodic tags are identified and prosodic tags corresponding to names of the subjects are stored in the database, the media files such as the audio and audio-video files may be prosodically tagged. A media file may be prosodically tagged by enlisting each of the prosodic tags present in the media file. For example, if in an audio file ‘A1’, voices of James and Ramesh are present, the audio file ‘A1’ may be prosodically tagged with PT_{Ramesh} and PT_{James}.

In an example embodiment, the media files may be clustered based on the prosodic tags determined in the media files. For example, for a prosodic tag, such as PT_{James}, each of the media files that comprises voice of subject ‘James’ (or those media files that are tagged by PT_{James}) are clustered, to form the cluster corresponding to PT_{James}. In an example embodiment, for each of the prosodic tags, corresponding clusters of the media files may be generated automatically.

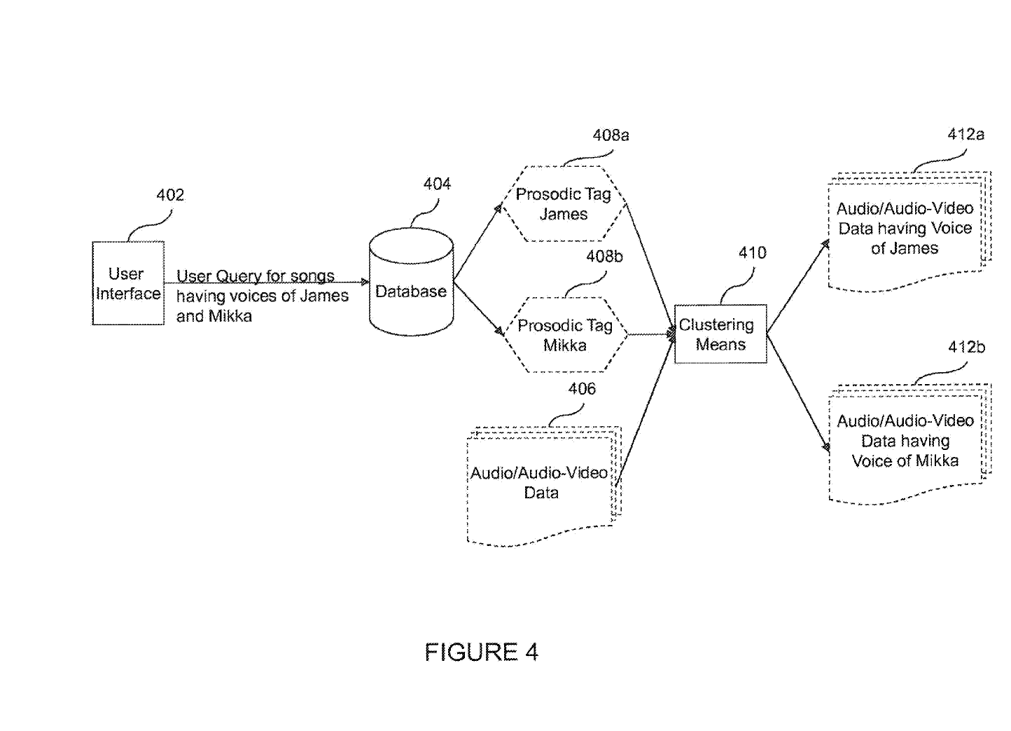

In some example embodiments, the media files may also be clustered based on a user query/input, any software program, instruction(s) or control. In an example embodiment, user, any software program, instructions or control may be able to provide query seeking for clusters of media files for a set of subject voices. In these embodiments, the query may be received by a user interface such as the user interface 206. Such clustering of media files based on the user query is illustrated in FIG. 4

FIG. 4 is a schematic diagram representing an example of clustering of media files, in accordance with an example embodiment. In an example embodiment, a user may provide his/her query for accessing songs corresponding to a set of subject voices, for example, of ‘James’ and ‘Mikka’. In an example embodiment, the user may provide his/her query for songs having voices of ‘James’ and ‘Mikka’ via a user interface 402. The user interface 402 may be an example of the user interface 206. In an example embodiment, the user query is provided to a database 404 that comprises the prosodic tags for different subjects. The database 404 may be an example of the database 310. In an example embodiment, the database 404 may store various prosodic tags corresponding to distinct voices present in unclustered media files such as audio/audio-video data 406.

In an example embodiment, appropriate prosodic tags based on the user query such as the PT_{James} (shown as 408a) and PT_{Mikka} (shown as 408b) may be provided to clustering means 410. In an example embodiment, the clustering means 410 also accepts the audio/audio-video data 406 as input. In an example embodiment, the clustering means 410 may be embodied in, or controlled by the processor 202 or the controller 108. In an example embodiment, the clustering means 410 forms a set of clusters for the set of subject voices in the user query. For example, audio/audio-video data having voices of ‘James’ (represented as audio/audio-video data 412a), and audio/audio-video data having voices of ‘Mikka’ (represented as audio/audio-video data 412b) may be clustered, separately. In another example embodiment, the clustering means 410 may also make a single cluster of media files which have voices of ‘James’ and ‘Mikka’.

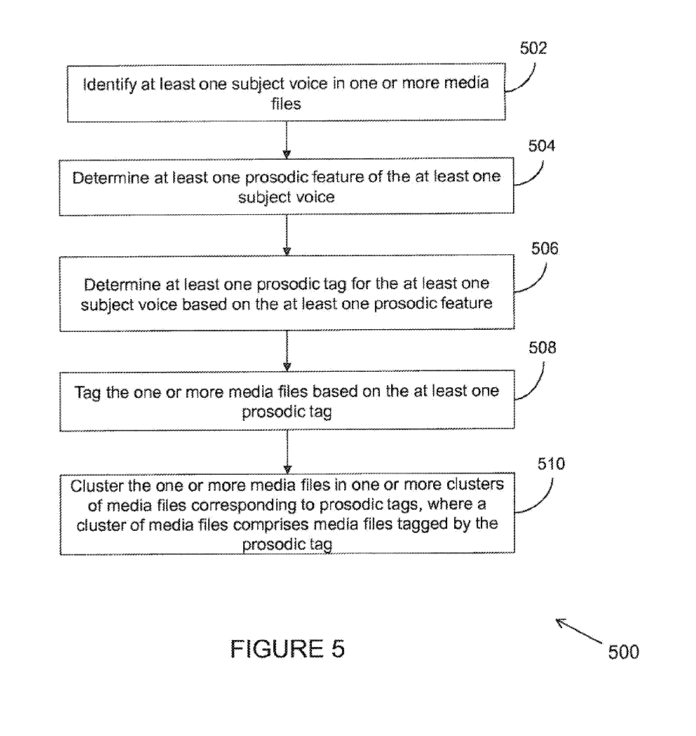

FIG. 5 is a flowchart depicting an example method 500 for prosodically tagging of one or more media files in accordance with an example embodiment. The method 500 depicted in flow chart may be executed by, for example, the apparatus 200 of FIG. 2. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 500 are described with help of apparatus 200. However, the operations of the method 500 can be described and/or practiced by using any other apparatus.

The flowchart diagrams that follow are generally set forth as logical flowchart diagrams. The depicted operations and sequences thereof are indicative of at least one embodiment. While various arrow types, line types, and formatting styles may be employed in the flowchart diagrams, they are understood not to limit the scope of the corresponding method. In addition, some arrows, connectors and other formatting features may be used to indicate the logical flow of the methods. For instance, some arrows or connectors may indicate a waiting or monitoring period of an unspecified duration. Accordingly, the specifically disclosed operations, sequences, and formats are provided to explain the logical flow of the method and are understood not to limit the scope of the present disclosure.

At block 502 of the method 500, at least one subject voice in one or more media files may be identified. For example, in media files, such as media files M1, M2 and M3, voices of different subjects (S1, S2 and S3) are identified. At block 504, at least one prosodic feature of the at least one subject voice is identified. In an example embodiment, prosodic features of a subject voice may include, but are not limited to, loudness, pitch variation, tone, tempo, rhythm and syllable length of the subject voice.

At block 506 of the method 500, at least one prosodic tag for the at least one subject voice is determined based on the at least one prosodic feature. For example, prosodic tags PT_{S1}, PT_{S2}, PT_{S3}, may be determined for the voices of the subjects S1, S2 and S3, respectively. In an example embodiment, the method 500 may facilitate storing of the prosodic tags (PT_{S1}, PT_{S2}, and PT_{S3}) for the voices of the subjects (S1, S2 and S3). In an example embodiment, the method 500 may facilitate storing of the prosodic tags (PT_{S1}, PT_{S2}, PT_{S3}) by receiving name of the subjects S1, S2 and S3, and facilitate storing of the prosodic tag (PT_{S1}, PT_{S2}, PT_{S3}) corresponding to the names of the subjects. For example, names of the subjects S1, S2 and S3, may be received as ‘James’, ‘Mikka’ and ‘Ramesh’, respectively. In an example embodiment, the prosodic tags (PT_{S1}, PT_{S2}, PT_{S3}) may be stored as prosodic tags corresponding to names of the subjects such as PT_{James}, PT_{Mikka} and PT_{Ramesh} in a database.

In some example embodiments, the method 500 may also comprise tagging the media files (M1, M2 and M3) based on the at least one prosodic tag, at block 508. In an example embodiment, tagging a media file comprises enlisting one or more prosodic tags corresponding to one or more subject voices present in the media file. For example, if the media file M1 comprises voices of subjects ‘Mikka’ and ‘Ramesh’, the media file M1 may be tagged with PT_{Mikka} and PT_{Ramesh}.

In some example embodiments, the method 500 may also comprise clustering the media files (M1, M2 and M3) based on the prosodic tags present in the media files, at block 510. In an example embodiment, a cluster corresponding to a prosodic tag comprises a group of those media files that comprises the subject voice corresponding to the prosodic tag. For example, cluster corresponding to the PT_{Ramesh} comprises each media files that comprise voices of Ramesh (or all media files that are tagged by PT_{Ramesh}). In an example embodiment, the clustering of the media files according to the prosodic tags may be performed automatically. In another example embodiment, the clustering of the media files according to the prosodic tags may be performed based on a user query or based on any software programs, instructions or control. For example, a user query may be received to form clusters for the voices of ‘Ramesh’ and ‘Mikka’ only, and accordingly, clusters of the media files which are tagged by PT_{Ramesh} and PT_{Mikka} may be generated separately or in a combined form.

In an example embodiment, a processing means may be configured to perform some or all of identifying at least one subject voice in one or more media files; means for determining at least one prosodic feature of the at least one subject voice; and means for determining at least one prosodic tag for the at least one subject voice based on the at least one prosodic feature. The processing means may further be configured to facilitate storing of the at least one prosodic tag for the at least one subject voice. The processing means may further be configured to facilitate storing of a prosodic tag by receiving name of a subject corresponding to the prosodic tag, and storing of the prosodic tag corresponding to the name of the subject in a database.

In an example embodiment, the processing means may be further configured to tag the one or more media files based on the at least one prosodic tag, wherein tagging a media file comprises enlisting one or more prosodic tags corresponding to one or more subject voices present in the media file. In an example embodiment, the processing means may be further configured to cluster the one or more media files in one or more clusters of media files corresponding to prosodic tags, wherein a cluster of media files corresponding to a prosodic tag comprises media files tagged by the prosodic tag. In an example embodiment, the processing means may be further configured to receive a query for accessing media files corresponding to a set of subjects voices, cluster the one or more media files in a set of clusters of media files corresponding to prosodic tags for the set of subject voices, wherein a cluster of media files corresponding to a prosodic tag comprises media files tagged by the prosodic tag.

Without in any way limiting the scope, interpretation, or application of the claims appearing below, a technical effect of one or more of the example embodiments disclosed herein is to organize media files such as audio and audio-video data. Various embodiments enable to sort media files based on people rather than metadata. Various embodiments provision for user interaction and hence are able to make clusters of media files bases on preferences of users. Further, various embodiments allows updating a database of prosodic tags by adding new prosodic tags for new identified voices and hence are dynamic in nature and have ability to learn.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer. If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-43. (canceled)

44. A method comprising:
identifying at least one subject voice in one or more media files;
determining at least one prosodic feature of the at least one subject voice; and
determining at least one prosodic tag for the at least one subject voice based on the at least one prosodic feature.

45. The method as claimed in claim 44, further comprising:
facilitating storing of the at least one prosodic tag for the at least one subject voice.

46. The method as claimed in claim 45, wherein facilitating storing of a prosodic tag comprises:
receiving name of a subject corresponding to the prosodic tag; and
facilitating storing of the prosodic tag corresponding to the name of the subject in a database.

47. The method as claimed in claim 44, further comprising:
tagging the one or more media files based on the at least one prosodic tag, wherein tagging a media file comprises enlisting one or more prosodic tags corresponding to one or more subject voices present in the media file.

48. The method as claimed in claim 44 further comprising:
clustering the one or more media files in one or more clusters of media files corresponding to prosodic tags, wherein a cluster of media files corresponding to a prosodic tag comprises media files tagged by the prosodic tag.

49. The method as claimed in claim 44 further comprising:
receiving a query for accessing media files corresponding to a set of subjects voices; and
clustering the one or more media files in a set of clusters of media files corresponding to prosodic tags for the set of subject voices, wherein a cluster of media files corresponding to a prosodic tag comprises media files tagged by the prosodic tag.

50. The method as claimed in claim 44, wherein the at least one subject voice comprises voice of at least one person.

51. The method as claimed in claim 44, wherein the at least one subject voice comprises voice of at least one of one or more non-human creatures, one or more manmade machines, or one or more natural objects.

52. An apparatus comprising:
at least one processor; and
at least one memory comprising computer program code, the at least one memory and the computer program code configured to, with the at least one processor, cause the apparatus at least to perform:
identify at least one subject voice in one or more media files;
determine at least one prosodic feature of the at least one subject voice; and
determine at least one prosodic tag for the at least one subject voice based on the at least one prosodic feature.

53. The apparatus as claimed in claim 52, wherein the apparatus is further caused, at least in part, to facilitate to store of the at least one prosodic tag for the at least one subject voice.

54. The apparatus as claimed in claim 53, wherein, to facilitate to store prosodic tag, the apparatus is further caused, at least in part, to perform:
receive name of a subject corresponding to the prosodic tag; and
facilitate storing of the prosodic tag corresponding to the name of the subject in a database.

55. The apparatus as claimed in claim 52, wherein the apparatus is further caused, at least in part, to tag the one or more media files based on the at least one prosodic tag, wherein tagging a media file comprises enlisting one or more prosodic tags corresponding to one or more subject voices present in the media file.

56. The apparatus as claimed in claim 52, wherein the apparatus is further caused, at least in part, to perform cluster the one or more media files in one or more clusters of media files corresponding to prosodic tags, wherein a cluster of media files corresponding to a prosodic tag comprises media files tagged by the prosodic tag.

57. The apparatus as claimed in claim 52, wherein the apparatus is further caused, at least in part, to perform:
receive a query for accessing media files corresponding to a set of subjects voices; and
cluster the one or more media files in a set of clusters of media files corresponding to prosodic tags for the set of subject voices, wherein a cluster of media files corresponding to a prosodic tag comprises media files tagged by the prosodic tag.

58. The apparatus as claimed in claim 52, wherein the at least one subject voice comprises voice of at least one person.

59. The apparatus as claimed in claim 52, wherein the at least one subject voice comprises voice of at least one of one or more non-human creatures, one or more manmade machines, or one or more natural objects.

60. A computer program product comprising a set of computer program instructions, which, when executed by one or more processors, cause an apparatus at least to perform:
identify at least one subject voice in one or more media files;
determine at least one prosodic feature of the at least one subject voice; and
determine at least one prosodic tag for the at least one subject voice based on the at least one prosodic feature.

61. The computer program as claimed in claim 60, wherein the apparatus is further caused, at least in part, to facilitate to store of the at least one prosodic tag for the at least one subject voice.

62. The computer program as claimed in claim 61, wherein, to store the prosodic tag, the apparatus is further caused, at least in part, to perform:
receive name of a subject corresponding to the prosodic tag; and
facilitate storing of the prosodic tag corresponding to the name of the subject in a database.

63. The computer program as claimed in claim 60, wherein the apparatus is further caused, at least in part, to tag the one or more media files based on the at least one prosodic tag, wherein tagging a media file comprises enlisting one or more prosodic tags corresponding to one or more subject voices present in the media file.
